(19) United States
(12) Patent Application Publication
(10) Pub. No.: US 2023/0411730 A1
(43) Pub. Date: Dec. 21, 2023

(54) THERMAL CONTROL ASSEMBLY HAVING PARTITIONING REGION AND ASSOCIATED METHOD

(71) Applicant: Ford Global Technologies, LLC, Dearborn, MI (US)

(72) Inventors: Bhaskara Rao Boddakayala, Troy, MI (US); James Lawrence Swoish, Northville, MI (US); Brian Utley, Canton, MI (US); Ravi Saripella, Farmington Hills, MI (US); Nihar Kotak, Ashburn, VA (US)

(21) Appl. No.: 17/845,137

(22) Filed: Jun. 21, 2022

(51) Int. Cl. H01M 10/6551; H01M 10/613; H01M 10/625

(52) U.S. Cl. CPC H01M 10/6551; H01M 10/613; H01M 10/625

(57) ABSTRACT

A battery pack assembly includes a first battery array, a second battery array adjacent the first battery array, a thermal control assembly that includes a thermal blanket spanning across the first battery array and the second battery array, and a partitioning region of the thermal control assembly. The partitioning region extends to a position between the first battery array and the second battery array. The partitioning region includes a foam core.

### TECHNICAL FIELD

This disclosure relates generally to a thermal control assembly and, more particularly, to a thermal control assembly having a partitioning region that extends between battery arrays of a traction battery pack.

### BACKGROUND

A battery pack of an electrified vehicle can include groups of battery cells arranged in one or more battery arrays. Busbars can be used to distribute electrical power to and from the battery cells, and to and from the battery pack. From time to time, thermal energy in one or more of the battery arrays can increase.

### SUMMARY

In some aspects, the techniques described herein relate to a battery pack assembly, including: a first battery array; a second battery array adjacent the first battery array; a thermal control assembly that includes a thermal blanket spanning across the first battery array and the second battery array; and a partitioning region of the thermal control assembly, the partitioning region extending to a position between the first battery array and the second battery array, the partitioning region including a foam core.

In some aspects, the techniques described herein relate to a battery pack assembly, wherein the partitioning region is sewn to the thermal blanket.

In some aspects, the techniques described herein relate to a battery pack assembly, further including an outer layer of the partitioning region, the outer layer wrapped around the foam core.

In some aspects, the techniques described herein relate to a battery pack assembly, wherein the outer layer includes silicon.

In some aspects, the techniques described herein relate to a battery pack assembly, wherein the outer layer further includes a glass-based mat.

In some aspects, the techniques described herein relate to a battery pack assembly, wherein the outer layer is provided by an area of the thermal blanket of the thermal control assembly.

In some aspects, the techniques described herein relate to a battery pack assembly, wherein the thermal blanket includes a mat layer that is glass-based and covered by a film coating.

In some aspects, the techniques described herein relate to a battery pack assembly, wherein the film coating includes a ceramic material.

In some aspects, the techniques described herein relate to a battery pack assembly, wherein the thermal blanket includes an inner layer having silicone, the inner layer sandwiched between a first fiber layer and a second fiber layer.

In some aspects, the techniques described herein relate to a battery pack assembly, wherein the first fiber layer, the second fiber layer, or both, include woven fibers.

In some aspects, the techniques described herein relate to a battery pack assembly, wherein the first fiber layer, the second fiber layer, or both, include glass-based fibers.

In some aspects, the techniques described herein relate to a battery pack assembly, wherein the partitioning region includes an indented area of the thermal blanket, the indented area backed with the foam core.

In some aspects, the techniques described herein relate to a battery pack assembly, further including an enclosure housing the first battery array, the second battery array, and the thermal control assembly.

In some aspects, the techniques described herein relate to a battery pack assembly, further including an electrical distribution system, the partitioning region directly contacting part of the electrical distribution system at the position between the first battery array and the second battery array.

In some aspects, the techniques described herein relate to a method of reducing thermal energy transfer within a battery pack, including; providing a thermal control assembly having a thermal blanket and a partitioning region, the partitioning region having a foam core; and positioning the thermal control assembly within a battery pack such that the thermal blanket spans across a first battery array and a second battery array, and the partitioning region extends to a position between the first battery array and the second battery array.

In some aspects, the techniques described herein relate to a method, further including securing the partitioning region to the thermal control assembly using thread.

In some aspects, the techniques described herein relate to a method, wherein the foam core of the partitioning region is wrapped in an outer layer that is not foam.

In some aspects, the techniques described herein relate to a method, wherein the outer layer is part of the thermal blanket.

In some aspects, the techniques described herein relate to a method, wherein the partitioning region is provided by an indented area of the thermal blanket, the indented area backed with the foam core.

In some aspects, the techniques described herein relate to a method, further including compression molding the thermal control assembly to provide the indented area.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 is a schematic side view of the battery pack of FIG. 1 having a thermal control assembly according to an exemplary aspect of the present disclosure.

FIG. 3 is a perspective view of the thermal control assembly of FIG. 2.

FIG. 4 is a close-up view of an area in FIG. 3.

FIG. 5 is a schematic side view of the battery pack of FIG. 1 having a thermal control assembly according to another exemplary aspect of the present disclosure.

FIG. 6 is a perspective view of the thermal control assembly of FIG. 5.

FIG. 7 is a close-up view of an area of the thermal control assembly of FIG. 6.

### DETAILED DESCRIPTION

A typical traction battery pack includes an enclosure having an interior. Battery arrays and other components are held within the interior. A thermal event in one battery array can cascade from one battery array of the battery pack to another battery array of the battery pack. This disclosure details exemplary thermal control assembly and methods that can reduce the likelihood of such a cascade.

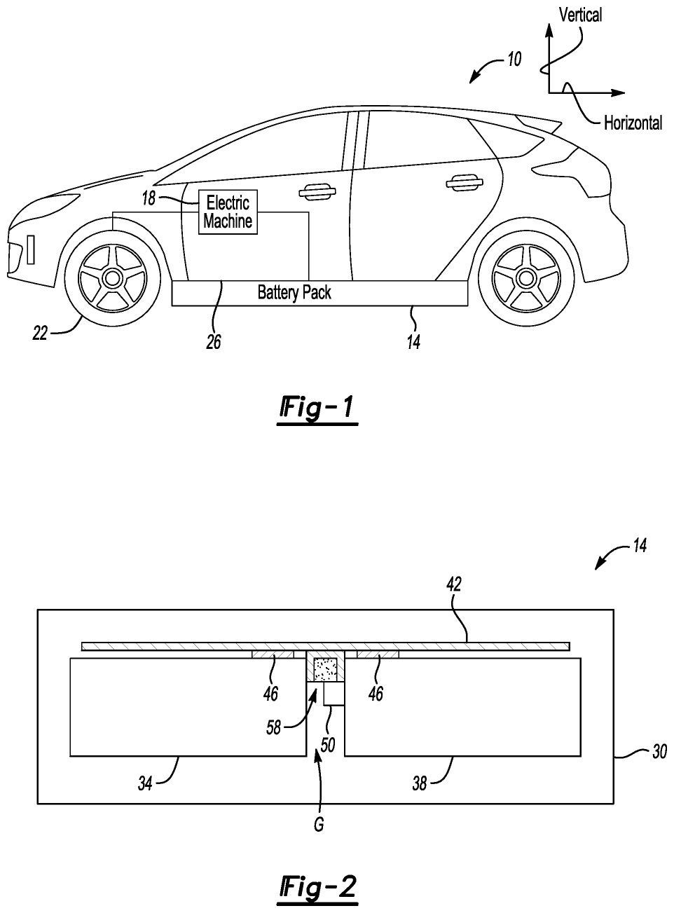

With reference to FIG. 1, an electrified vehicle 10 includes a traction battery pack 14 and an electric machine 18, and wheels 22. The battery pack 14 powers an electric machine 18, which converts electric power to torque to drive the wheels 22. The battery pack 14 can be a relatively high-voltage battery.

The battery pack 14 is, in the exemplary embodiment, secured to an underbody 26 of the electrified vehicle 10. The battery pack 14 could be located elsewhere on the electrified vehicle 10 in other examples. The battery pack 14 can be secured to the underbody 26 using straps and mechanical fasteners, for example.

The electrified vehicle 10 is an all-electric vehicle. In other examples, the electrified vehicle 10 is a hybrid electric vehicle, which selectively drives wheels using torque provided by an internal combustion engine instead, or in addition to, an electric machine. Generally, the electrified vehicle 10 could be any type of vehicle having a traction battery pack.

Referring now to FIGS. 2-4 with continuing reference to FIG. 1, the battery pack 14 includes an enclosure 30 housing, among other things, at least a first battery array 34, a second battery array 38, and a thermal control assembly 42.

The first battery array 34 is disposed horizontally adjacent to, but spaced a distance from, the second battery array 38 to provide a gap G between the first battery array 34 and the second battery array 38. The thermal control assembly 42 spans across vertically upper surfaces of the first battery array 34 and the second battery array 38. The thermal control assembly 42 spans across the gap G.

Vertical and horizontal are, for purposes of this disclosure, with reference to ground and a general orientation of the electrified vehicle 10 and battery pack 14 during operation.

An electrical distribution system of the battery pack 14 can include busbars 46 electrically coupled to the first battery array 34 and the second battery array 38. The electrical distribution system can include components, such as electrical connectors 50, situated between the first battery array 34 and the second battery array 38 within the gap G.

The thermal control assembly 42 includes a thermal blanket 54, a partitioning region 58, and a foam core 62. In this example, the thermal blanket 54 extends over the first battery array 34, the gap G, and the second battery array 38. The partitioning region 58 extends vertically downward from the thermal blanket 54 to a position within the gap G. The thermal control assembly 42 can block thermal energy transfer between the first battery array 34 and the second battery array 38.

The thermal blanket 54 is, in the exemplary embodiment, a multilayer structure having a first layer 70 that is a mat layer, and a second layer 74 that is a film coating. The mat layer can include woven or non-woven fibers. In this example, the mat layer is glass-based. The film coating can include ceramic material, which can help to electrically insulate the thermal blanket 54. The mat layer can be covered by the film coating.

The foam core 62 is part of the partitioning region 58 of the thermal control assembly 42. The foam core 62 can be a foam material configured to withstand high temperatures, such as temperatures above 1000 Celsius. The foam core 62 can be wrapped in an outer layer, such as a film 78, which can be a multilayer film having a silicone layer and a glass-based mat layer. The foam core 62 and film 78 help to block thermal energy from moving from the first battery array 34 to the second battery array 38 and vice versa.

Extending the partitioning region 58 vertically downward into the gap G facilitates blocking such movement of thermal energy. In this example, the partitioning region 58 extends into the gap G and directly contacts the electrical connectors 50 of the electrical distribution system. The partitioning region 58 could directly contact another component of the electrical distribution system in another example.

The partitioning region 58 can be sewn to the thermal blanket 54 to secure the partitioning region 58 to the thermal blanket 54. The thread used for sewing the partitioning region can be an electrically insulating thread configured to withstand high temperatures, such as temperatures above 1000 Celsius.

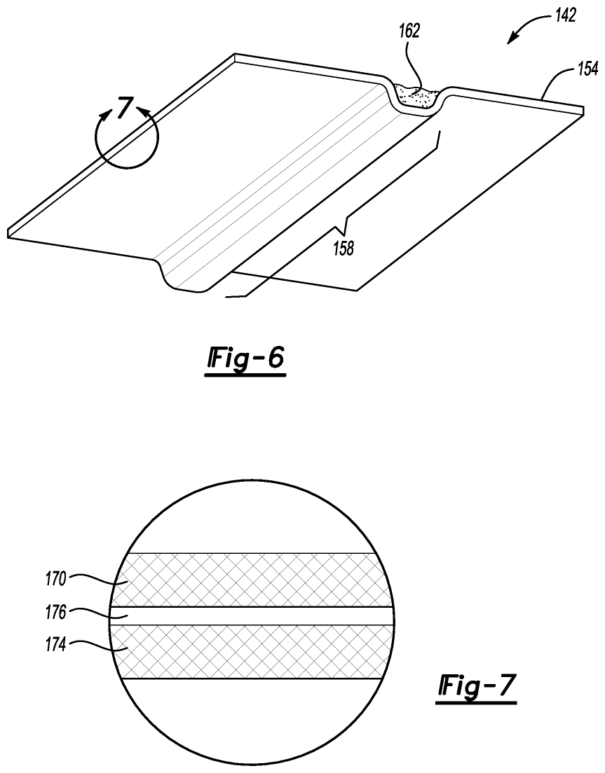

With reference now to FIGS. 5-7, a thermal control assembly 142 according to another example embodiment of the present disclosure includes a thermal blanket 154, a partitioning region 158, and a foam core 162. The thermal control assembly 142 can block thermal energy transfer between the first battery array 34 and the second battery array 38.

In this disclosure, like reference numerals designate like elements where appropriate, and reference numerals with the addition of one-hundred or multiples thereof designate modified elements. The modified elements incorporate the same features and benefits of the corresponding modified elements, expect where stated otherwise.

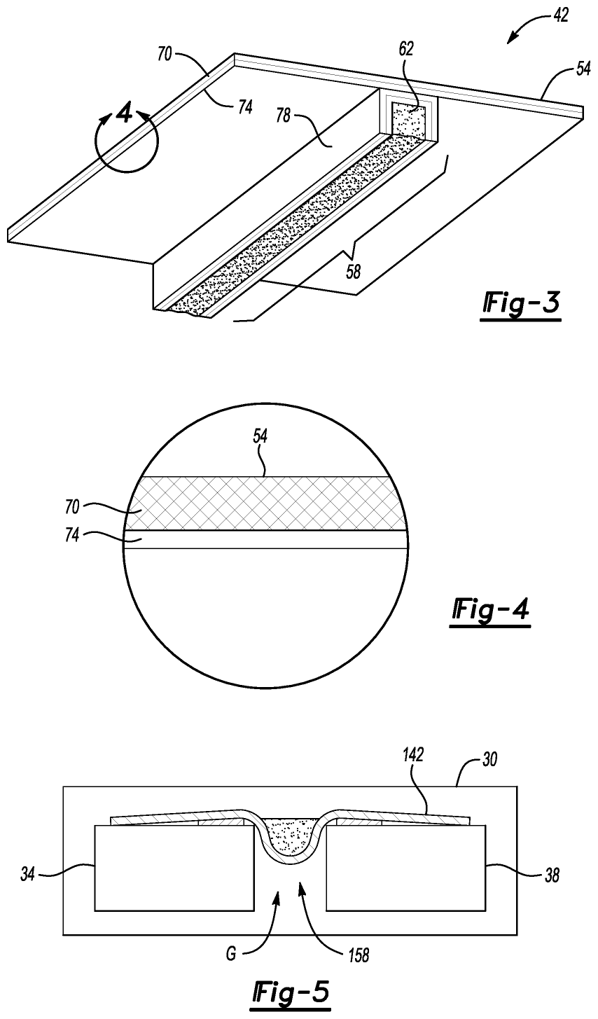

In this example, like thermal control assembly 42 in the embodiment in FIGS. 2-3, the thermal blanket 154 extends over the first battery array 34, the gap G, and the second battery array 38. Also, the partitioning region 158 extends vertically downward from the thermal blanket 54 to a position within the gap G. Like the partitioning region 58 of the thermal control assembly 42, the partitioning region 158 could extend into the gap G and contact a component of an electrical distribution system.

The foam core 162 is part of the partitioning region 158 of the thermal control assembly 142. The foam core 162 be wrapped in an outer layer, which is provided by an area of the thermal blanket 154 in this embodiment. In an example, the thermal blanket 154 is compression formed to include an indented area, which is backed with the foam core 162 to provide the partitioning region 158 of the thermal control assembly 142.

The thermal blanket 154 is, in the exemplary embodiment, a multilayer structure having a first layer 170, a second layer 174, and a third layer 176. The first layer 170 and the second layer 174 can be fiber layers that sandwich the third layer 176. The fibers of the first layer 170 the second layer 174, or both, can be woven or non-woven. The fibers of the first layer 170, the second layer 174, or both can include glass-based fibers.

The third layer 176 can be consider an inner layer as the third layer 176 is sandwiched between the first layer 170 and the second layer 174. The third layer 176 is a silicone-based layer in this example.

The example thermal blanket 154 has three layers. In another example, the thermal blanket 154 is constructed differently. For example, the thermal blanket 154 could instead have two layers like the thermal blanket 54. Similarly, the example thermal blanket 54 of the FIGS. 2-4 embodiment could be constructed differently. For example, the thermal blanket 54 could instead have three layers like the thermal blanket 154 of the FIGS. 5-7 embodiment.

In other examples, the thermal blanket 54 or the thermal blanket 154 can include four layers. A first layer can be a basalt mesh. A second layer can be a silicone adhesive. A third layer can be a silicone mixed with endothermic fillers, such as 1 to 2% (Aluminum Trihydrate) or Sodium silicate and 0.5 to 1% of Aerogel particles. A fourth layer can be a glass-based cloth layer. The four layers can be pressed together using vacuum with resin impregnations. The four layers could be compression molded to form desired features, such as the indented area that establishes part of the partitioning region 158 of the thermal control assembly 142.

Features of the disclosed examples, include using a partitioning region of a thermal control assembly to mitigate thermal energy transfer between battery arrays and other components. The partitioning region is integrated into the thermal control assembly, which includes a thermal blanket. Installing a separate thermal barrier thus may not be required, which can reduce complexity. The partitioning region is installed as the thermal blanket is positioned on top of battery arrays.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly, comprising:
a first battery array;
a second battery array adjacent the first battery array;
a thermal control assembly that includes a thermal blanket spanning across the first battery array and the second battery array; and
a partitioning region of the thermal control assembly, the partitioning region extending to a position between the first battery array and the second battery array, the partitioning region including a foam core.

2. The battery pack assembly of claim 1, wherein the partitioning region is sewn to the thermal blanket.

3. The battery pack assembly of claim 1, further comprising an outer layer of the partitioning region, the outer layer wrapped around the foam core.

4. The battery pack assembly of claim 3, wherein the outer layer includes silicon.

5. The battery pack assembly of claim 4, wherein the outer layer further includes a glass-based mat.

6. The battery pack assembly of claim 3, wherein the outer layer is provided by an area of the thermal blanket of the thermal control assembly.

7. The battery pack assembly of claim 1, wherein the thermal blanket includes a mat layer that is glass-based and covered by a film coating.

8. The battery pack assembly of claim 7, wherein the film coating includes a ceramic material.

9. The battery pack assembly of claim 1, wherein the thermal blanket includes an inner layer having silicone, the inner layer sandwiched between a first fiber layer and a second fiber layer.

10. The battery pack assembly of claim 9, wherein the first fiber layer, the second fiber layer, or both, include woven fibers.

11. The battery pack assembly of claim 9, wherein the first fiber layer, the second fiber layer, or both, include glass-based fibers.

12. The battery pack assembly of claim 1, wherein the partitioning region comprises an indented area of the thermal blanket, the indented area backed with the foam core.

13. The battery pack assembly of claim 1, further comprising an enclosure housing the first battery array, the second battery array, and the thermal control assembly.

14. The battery pack assembly of claim 1, further comprising an electrical distribution system, the partitioning region directly contacting part of the electrical distribution system at the position between the first battery array and the second battery array.

15. A method of reducing thermal energy transfer within a battery pack, comprising;
providing a thermal control assembly having a thermal blanket and a partitioning region, the partitioning region having a foam core; and
positioning the thermal control assembly within a battery pack such that the thermal blanket spans across a first battery array and a second battery array, and the partitioning region extends to a position between the first battery array and the second battery array.

16. The method of claim 15, further comprising securing the partitioning region to the thermal control assembly using thread.

17. The method of claim 15, wherein the foam core of the partitioning region is wrapped in an outer layer that is not foam.

18. The method of claim 17, wherein the outer layer is part of the thermal blanket.

19. The method of claim 15, wherein the partitioning region is provided by an indented area of the thermal blanket, the indented area backed with the foam core.

20. The method of claim 19, further comprising compression molding the thermal control assembly to provide the indented area.
